(19) United States
(12) Patent Application Publication
(10) Pub. No.: US 2025/0254617 A1
(43) Pub. Date: Aug. 7, 2025

(54) METHODS AND APPARATUSES OF A POWER SAVING MECHANISM FOR XR TRAFFIC

(71) Applicant: Lenovo (Beijing) Limited, Beijing (CN)

(72) Inventors: Xiaoying Xu, Shanghai (CN); Mingzeng Dai, Shanghai (CN); Lianhai Wu, Beijing (CN); Jing Han, Beijing (CN); Congchi Zhang, Shanghai (CN)

(73) Assignee: Lenovo (Beijing) Limited, Beijing (CN)

(21) Appl. No.: 18/855,774

(22) PCT Filed: May 27, 2022
(86) PCT No.: PCT/CN2022/095712

§ 371 Date: Oct. 10, 2024

(51) Int. Cl. H04W 52/02; H04W 76/28

(52) U.S. Cl. CPC H04W 52/0216; H04W 52/0235; H04W 76/28

(57) ABSTRACT

Embodiments of the subject application relate to methods and apparatuses of a power saving mechanism for extended reality (XR) traffic. According to an embodiment of the subject application, a user equipment (UE) includes a processor and a transceiver coupled to the processor; and the processor is configured to: receive a first configuration for one or more serving cells in a discontinuous reception (DRX) group via the transceiver from a network, wherein the first configuration includes at least one of: DRX cycle information used for determining a non-integer length value of a DRX cycle; or DRX start offset information which indicates an offset value related to a reference system frame number (SFN) in a time domain; and determine first start timing of an on-duration window for the DRX group in the time domain according to at least one of the DRX cycle information or the DRX start offset information.

### TECHNICAL FIELD

Embodiments of the subject application generally relate to wireless communication technology, in particular to methods and apparatuses of a power saving mechanism for extended reality (XR) traffic.

### BACKGROUND

Extended reality (XR), including augmented reality (AR) and virtual reality (VR), as well as cloud gaming (CG), presents a new promising category of connected devices, applications, and services. As a potential working area of 3GPP (3rd generation partnership project) Rel-18, power saving of a XR device is one of key topics. Currently, details regarding a power saving mechanism for XR traffic have not been discussed vet.

### SUMMARY

Some embodiments of the subject application also provide a user equipment (UE). The UE includes a processor and a transceiver coupled to the processor; and the processor is configured to: receive a first configuration for one or more serving cells in a discontinuous reception (DRX) group via the transceiver from a network, wherein the first configuration includes at least one of: DRX cycle information used for determining a non-integer length value of a DRX cycle; or DRX start offset information which indicates an offset value related to a reference system frame number (SFN) in a time domain; and determine first start timing of an on-duration window for the DRX group in the time domain according to at least one of the DRX cycle information or the DRX start offset information.

In some embodiments, the processor of the UE is configured to determine second start timing of the on-duration window for the DRX group in the time domain according to at least one of the DRX cycle information or the DRX start offset information.

In some embodiments, the first configuration further includes information associated with the reference SFN, and at least one of the first start timing or the second start timing of the on-duration window is further determined according to the information associated with the reference SFN.

In some embodiments, the DRX cycle information includes one of: a downlink (DL) frame rate in the time domain, wherein the non-integer length value is determined based on the DL frame rate; and the non-integer length value.

In some embodiments, a unit is the offset value is associated with one of: a subframe, a slot, and a symbol.

In some embodiments, the processor of the UE is configured to: receive a second configuration for the one or more serving cells in the DRX group via the transceiver from the network, wherein the second configuration indicates a subset of the on-duration window; and monitor a physical downlink control channel (PDCCH) transmission in the subset of the on-duration window according to the second configuration.

In some embodiments, the second configuration includes at least one of: a bitmap indication associated with the on-duration window; or an information list associated with one or more subsets of the on-duration window.

In some embodiments, the information list indicates at least one of: start timing of a subset within the one or more subsets of the on-duration window; or a length of the subset within the one or more subsets of the on-duration window.

In some embodiments, at least one of the first start timing of the on-duration window, the second start timing of the on-duration window, or the start timing of the subset within the one or more subsets is a start sub-frame or a start slot or a start symbol.

In some embodiments, the second configuration indicates which occasions in the time domain are needed for monitoring the PDCCH transmission in the subset of the on-duration window.

In some embodiments, the second configuration is received via radio resource control (RRC) signalling or a dynamic command.

In some embodiments, the processor of the UE is configured to transmit jitter range information via the transceiver to the network, and wherein the jitter range information includes at least one of: a UL jitter range of data arrival time at the UE; or a probability of the UL jitter range.

In some embodiments, the processor of the UE is configured to receive single downlink control information (DCI) used for scheduling multiple slots in the time domain for a downlink (DL) or an uplink (UL) of the UE via the transceiver from the network on a serving cell in the DRX group, and wherein each slot within the multiple slots is corresponding to a unique hybrid automatic repeat request (HARQ) process of the UE.

In some embodiments, in response to the single DCI used for scheduling the multiple slots for the DL or the UL and in response to receiving a PDCCH transmission indicating a new DL or UL transmission within the multiple slots on the serving cell in the DRX group, the processor of the UE is configured to: not start a DRX inactivity timer for the DRX group; or delay start timing of the DRX inactivity timer for the DRX group till a firstly appeared symbol in the time domain after ending timing of a last physical downlink shared channel (PDSCH) transmission within the multiple slots.

In some embodiments, in response to the single DCI used for scheduling the multiple slots for the UL and in response to an expiry of a DRX hybrid automatic repeat request (HARQ) round trip time (RTT) timer for a physical uplink share channel (PUSCH) transmission within the multiple slots for a corresponding HARQ process, the processor of the UE is configured to start a DRX retransmission timer for the UL for the corresponding HARQ process at later timing between: a firstly appeared symbol in the time domain after the expiry of the DRX HARQ RTT timer for the UL; and a firstly appeared symbol in the time domain after ending timing of a last PUSCH transmission within the multiple slots.

Some embodiments of the subject application also provide a user equipment (UE). The UE includes a processor and a transceiver coupled to the processor; and the processor is configured to: receive a second configuration for one or more serving cells in a discontinuous reception (DRX) group via the transceiver from a network, wherein the second configuration indicates a subset of an on-duration window for the DRX group in a time domain, and monitor a physical downlink control channel (PDCCH) transmission in the subset of the on-duration window according to the second configuration.

In some embodiments, the second configuration includes at least one of: a bitmap indication associated with the on-duration window; or an information list associated with one or more subsets of the on-duration window.

In some embodiments, the information list indicates at least one of: start timing of a subset within the one or more subsets of the on-duration window; or a length of the subset within the one or more subsets of the on-duration window.

In some embodiments, the second configuration indicates which occasions in the time domain are needed for monitoring the PDCCH transmission in the subset of the on-duration window.

In some embodiments, the processor of the UE is configured to: receive first information associated with a DRX on-duration window length via the transceiver from the network; receive DRX slot offset information which indicates a slot delay value before starting the DRX on-duration window in the time domain via the transceiver from the network; receive second information associated with the DRX cycle and a start offset value of the DRX cycle in the time domain via the transceiver from the network; and determine first start timing of the on-duration window for the DRX group in the time domain according to at least one of the first information, the DRX slot offset information, or the second information.

In some embodiments, the processor of the UE is configured to determine second start timing of the on-duration window in the time domain according to at least one of the first information, the DRX slot offset information, or the second information.

In some embodiments, the processor of the UE is configured to: receive a first configuration for the one or more serving cells in the DRX group via the transceiver from the network, wherein the first configuration includes at least one of: DRX cycle information used for determining a non-integer length value of a DRX cycle; or DRX start offset information which indicates an offset value related to a reference system frame number (SFN) in the time domain; and determine first start timing of the on-duration window for the DRX group in the time domain according to at least one of the DRX cycle information or the DRX start offset information.

In some embodiments, the processor of the UE is configured to determine second start timing of the on-duration window in the time domain according to at least one of the DRX cycle information or the DRX start offset information.

In some embodiments, at least one of the start timing of the subset within the one or more subsets, the first start timing of the on-duration window, or the second start timing of the on-duration window is a start sub-frame or a start slot or a start symbol.

In some embodiments, the first configuration further includes information associated with the reference SFN, and wherein the start timing of the on-duration window is further determined according to the information associated with the reference SFN.

In some embodiments, the DRX cycle information includes one of: a downlink (DL) frame rate in the time domain, wherein the non-integer length value is determined based on the DL frame rate; and the non-integer length value.

In some embodiments, a unit is the offset value is associated with one of: a subframe, a slot, and a symbol.

In some embodiments, the processor of the UE is configured to transmit jitter range information via the transceiver to the network, and wherein the jitter range information includes at least one of: a UL jitter range of data arrival time at the UE; or a probability of the UL jitter range.

In some embodiments, the processor of the UE is configured to receive single downlink control information (DCI) used for scheduling multiple slots in the time domain for a downlink (DL) or an uplink (UL) of the UE via the transceiver from the network on a serving cell in the DRX group, and wherein each slot within the multiple slots is corresponding to a unique hybrid automatic repeat request (HARQ) process of the UE.

In some embodiments, in response to the single DCI used for scheduling the multiple slots for the DL or the UL and in response to receiving a PDCCH transmission indicating a new DL or UL transmission within the multiple slots, the processor of the UE is configured to: not start a DRX inactivity timer for the DRX group; or delay start timing of the DRX inactivity timer for the DRX group till a firstly appeared symbol in the time domain after ending timing of a last physical downlink shared channel (PDSCH) transmission within the multiple slots.

In some embodiments, in response to the single DCI used for scheduling the multiple slots for the UL and in response to an expiry of a DRX hybrid automatic repeat request (HARQ) round trip time (RTT) timer for a physical uplink share channel (PUSCH) transmission within the multiple slots for a corresponding HARQ process, the processor of the UE is configured to start a DRX retransmission timer for the UL for the corresponding HARQ process at later timing between: a firstly appeared symbol in the time domain after the expiry of the DRX HARQ RTT timer for the UL; and a firstly appeared symbol in the time domain after ending timing of a last PUSCH transmission within the multiple slots.

Some embodiments of the subject application also provide a user equipment (UE). The UE includes a processor and a transceiver coupled to the processor; and the processor is configured to receive a configuration regarding downlink control information (DCI) with cyclic redundancy check (CRC) scrambled by power saving radio network temporary identifier (PS-RNTI) (DCP) functionality via the transceiver from a network, wherein the configuration includes at least one of: DCP cycle information used for determining a non-integer length value of a DCP cycle; DCP start offset information which indicates an offset value related to a reference system frame number (SFN) in a time domain; DCP slot offset information which indicates a slot delay value before starting a DCP on-duration window in the time domain; or DCP on-duration information indicating which occasions in the time domain are needed for monitoring a physical downlink control channel (PDCCH) transmission in an on-duration window of the DCP cycle.

In some embodiments, the processor of the UE is configured to determine start timing of an on-duration window of one DRX cycle in the time domain according to at least one of the DCP slot offset information, the DCP cycle information, or the DCP start offset information.

In some embodiments, the start timing of the on-duration window is a start sub-frame or a start slot or a start symbol.

In some embodiments, the processor of the UE is configured to monitor the PDCCH transmission in the on-duration window of the DCP cycle according to the DCP on-duration information.

In some embodiments, the DCP on-duration information is a bitmap indication or an information list associated with the on-duration window.

In some embodiments, the configuration is received via radio resource control (RRC) signalling or a dynamic command.

Some embodiments of the subject application also provide a network node (e.g., a base station (BS)). The network node includes a processor and a transceiver coupled to the processor; and the processor is configured to: receive a capability supporting an operation for determining start timing of an on-duration window for a discontinuous reception (DRX) group in a time domain of a user equipment (UE) via the transceiver from the UE; and transmit a configuration for one or more serving cells in the DRX group via the transceiver to the UE, wherein the configuration includes at least one of: DRX cycle information used for determining a non-integer value of a DRX cycle; DRX start offset information which indicates an offset value related to a reference system frame number (SFN) in the time domain; or information associated with the reference SFN.

In some embodiments, the start timing of the on-duration window is a start sub-frame or a start slot or a start symbol.

Some embodiments of the subject application also provide a network node (e.g., a BS). The network node includes a processor and a transceiver coupled to the processor; and the processor is configured to: receive a capability supporting an operation for monitoring a physical downlink control channel (PDCCH) transmission in a subset of an on-duration window for a discontinuous reception (DRX) group of a user equipment (UE) via the transceiver from the UE; and transmit a configuration for one or more serving cells in the DRX group via the transceiver to the UE, wherein the configuration indicates a subset of the on-duration window for the DRX group in a time domain.

In some embodiments, the configuration indicates which occasions in the time domain are needed for monitoring the PDCCH transmission in the subset of the on-duration window.

In some embodiments, the configuration is transmitted via radio resource control (RRC) signalling or a dynamic command.

In some embodiments, the processor of the network node is configured to receive jitter range information via the transceiver from the UE or a core network (CN), and wherein the jitter range information includes at least one of: a DL jitter range of data arrival time at the network node; a UL jitter range of data arrival time at the UE; a probability of the DL jitter range; or a probability of the UL jitter range.

Some embodiments of the subject application also provide a network node (e.g., a BS). The network node includes a processor and a transceiver coupled to the processor; and the processor is configured to: receive a capability supporting an operation for determining start timing of an on-duration window of a downlink control information (DCI) with cyclic redundancy check (CRC) scrambled by a power saving radio network temporary identifier (PS-RNTI) (DCP) cycle in a time domain of a user equipment (UE) via the transceiver from the UE; and transmit a configuration regarding DCP functionality via the transceiver to the UE, wherein the configuration includes at least one of: DCP cycle information used for determining a non-integer length value of a DCP cycle; DCP start offset information which indicates an offset value related to a reference system frame number (SFN) in a time domain; DCP slot offset information which indicates a slot delay value before starting a DCP on-duration window in the time domain; or DCP on-duration information indicating which occasions in the time domain are needed for monitoring a physical downlink control channel (PDCCH) transmission in an on-duration window of the DCP cycle.

In some embodiments, the DCP on-duration information is a bitmap indication or an information list associated with the on-duration window.

In some embodiments, the configuration is transmitted via radio resource control (RRC) signalling or a dynamic command.

In some embodiments, the start timing of the on-duration window is a start sub-frame or a start slot or a start symbol.

Some embodiments of the subject application provide a method, which may be performed by a UE. The method includes: receiving a configuration for serving cells in a discontinuous reception (DRX) group from a network, wherein the configuration includes at least one of: DRX cycle information which used for determining a non-integer length value of a DRX cycle; or DRX start offset information which indicates an offset value related to a reference system frame number (SFN) in a time domain; and determining start timing of an on-duration window for the DRX group according to at least one of the DRX cycle information or the DRX start offset information.

Some embodiments of the subject application provide a method, which may be performed by a UE. The method includes: receiving a configuration for one or more serving cells in a discontinuous reception (DRX) group from a network, wherein the configuration indicates a subset of an on-duration window for the DRX group in a time domain; and monitoring a physical downlink control channel (PDCCH) transmission in the subset of the on-duration window according to the configuration.

Some embodiments of the subject application provide a method, which may be performed by a UE. The method includes: receiving a configuration regarding downlink control information (DCI) with cyclic redundancy check (CRC) scrambled by a power saving radio network temporary identifier (PS-RNTI) (DCP) functionality from a network, wherein the configuration includes at least one of: DCP cycle information used for determining a non-integer length value of a DCP cycle; DCP start offset information which indicates an offset value related to a reference system frame number (SFN) in a time domain; DCP slot offset information which indicates a slot delay value before starting a DCP on-duration window in the time domain; or DCP on-duration information indicating which occasions in the time domain are needed for monitoring a physical downlink control channel (PDCCH) transmission in an on-duration window of the DCP cycle.

Some embodiments of the subject application provide a method, which may be performed by a network node (e.g., a BS). The method includes: receiving a capability supporting an operation for determining start timing of an on-duration window for a discontinuous reception (DRX) group in a time domain of a user equipment (UE) from the UE; and transmitting a configuration for one or more serving cells in the DRX group to the UE, wherein the configuration includes at least one of: DRX cycle information used for determining a non-integer value of a DRX cycle; DRX start offset information which indicates an offset value related to a reference system frame number (SFN) in the time domain; or information associated with the reference SFN.

Some embodiments of the subject application provide a method, which may be performed by a network node (e.g., a BS). The method includes: receiving a capability supporting an operation for monitoring a physical downlink control channel (PDCCH) transmission in a subset of an on-duration window for a discontinuous reception (DRX) group of a user equipment (UE) from the UE; and transmitting a configuration for one or more serving cells in the DRX group to the UE, wherein the configuration indicates a subset of the on-duration window for the DRX group in a time domain.

Some embodiments of the subject application provide a method, which may be performed by a network node (e.g., a BS). The method includes: receiving a capability supporting an operation for determining start timing of an on-duration window of a downlink control information (DCI) with cyclic redundancy check (CRC) scrambled by a power saving radio network temporary identifier (PS-RNTI) (DCP) cycle in a time domain of a user equipment (UE) from the UE; and transmitting a configuration regarding DCP functionality to the UE, wherein the configuration includes at least one of: DCP cycle information used for determining a non-integer length value of a DCP cycle; DCP start offset information which indicates an offset value related to a reference system frame number (SFN) in a time domain: DCP slot offset information which indicates a slot delay value before starting a DCP on-duration window in the time domain; or DCP on-duration information indicating which occasions in the time domain are needed for monitoring a physical downlink control channel (PDCCH) transmission in an on-duration window of the DCP cycle.

Some embodiments of the subject application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE or a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the subject application.

FIGS. 2A and 2B illustrate exemplary schematic diagrams of non-integer periodicity of XR traffic in accordance with some embodiments of the subject application.

FIG. 3 illustrates an exemplary flowchart for receiving a configuration for a serving cell in a DRX group in accordance with some embodiments of the subject application.

FIG. 4 illustrates an exemplary flowchart for transmitting a configuration for a serving cell in a DRX group in accordance with some embodiments of the subject application.

FIGS. 5-7 illustrate exemplary schematic diagrams of supporting a non-integer DRX cycle in accordance with some embodiments of the subject application.

FIG. 8 illustrates an exemplary flowchart for receiving a configuration for a serving cell in a DRX group in accordance with some embodiments of the subject application.

FIG. 9 illustrates an exemplary flowchart for transmitting a configuration for a serving cell in a DRX group in accordance with some embodiments of the subject application.

FIG. 10 illustrates an exemplary diagram of a XR traffic arrival with a jitter range in accordance with some embodiments of the subject application.

FIGS. 11 and 12 illustrate exemplary schematic diagrams for a sparse DRX on-duration set by a bitmap in accordance with some embodiments of the subject application.

FIG. 13 illustrates an exemplary diagram of a MAC subPDU in accordance with some embodiments of the subject application.

FIG. 14 illustrates an exemplary diagram regarding a DRX timer in accordance with some embodiments of the subject application.

FIG. 15 illustrates an exemplary flowchart of a configuration regarding DCP functionality in accordance with some embodiments of the subject application.

FIG. 16 illustrates an exemplary schematic diagram for a sparse DCP on-duration-time set by a bitmap in accordance with some embodiments of the subject application.

FIGS. 17 and 18 illustrate exemplary block diagrams of an apparatus for a power saving operation in accordance with some embodiments of the subject application.

### DETAILED DESCRIPTION

The detailed description of the appended drawings is intended as a description of preferred embodiments of the subject application and is not intended to represent the only form in which the subject application may be practiced. It should be understood that the same or equivalent functions may be accomplished by different embodiments that are intended to be encompassed within the spirit and scope of the subject application.

Reference will now be made in detail to some embodiments of the subject application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced. 6G, and so on. It is contemplated that along with developments of network architectures and new service scenarios, all embodiments in the subject application are also applicable to similar technical problems; and moreover, the terminologies recited in the subject application may change, which should not affect the principle of the subject application.

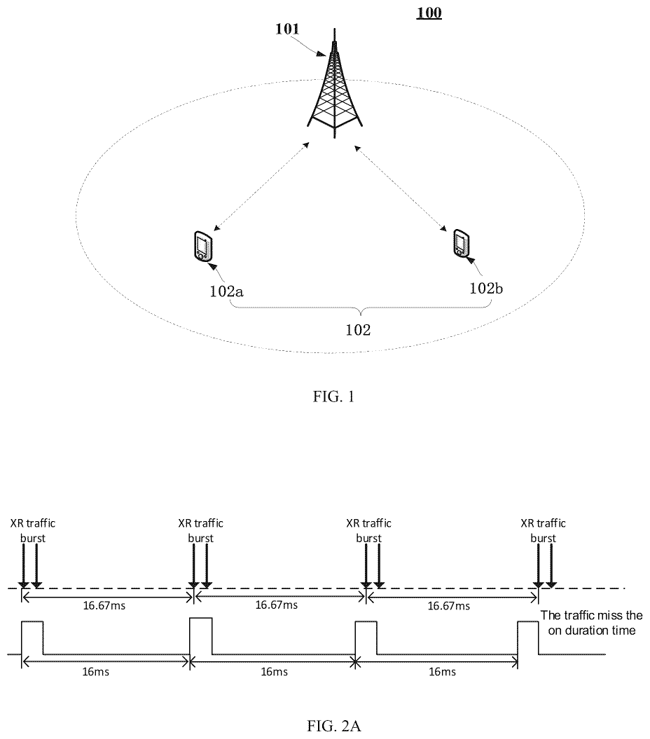

FIG. 1 illustrates a schematic diagram of a wireless communication system in accordance with some embodiments of the subject application.

As shown in FIG. 1, the wireless communication system 100 includes at least one base station (BS) 101 and at least one UE 102. In particular, the wireless communication system 100 includes one BS 101 and two UEs 102 (e.g., a UE 102a and a UE 102b) for illustrative purpose. Although a specific number of BS 101 and UEs 102 are depicted in FIG. 1, it is contemplated that any number of BSs 101 and UEs 102 may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

BS 101 may also be referred to as a NG-RAN node, a RAN node, an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to BS 101.

According to some embodiments of the subject application, UE(s) 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some other embodiments of the subject application, UE(s) 102 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the subject application, UE(s) 102 may include wearable devices, such as smart watches, fitness bands, optical head-mounted displays, or the like. Moreover, UE(s) 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

Both UE 102a and UE 102b in the embodiments of FIG. 1 may transmit information to BS 101 and receive control information from BS 101, for example, via LTE or NR Uu interface.

Typically, for XR services, DRX is a key feature for power saving in the UE. In DRX active time, a UE monitors a PDCCH transmission for the MAC entity's C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, and AI-RNTI. It allows the UE to stop monitoring PDCCH during periods of time when there is no data activity, thereby saving power. However, using DRX for power saving of XR traffic is facing some challenges.

For example, typical XR DL frame rates may be 60 or 120 frames per a second (fps), of which a frame periodicity is 16.67 ms (i.e., 1000 ms/60) or 8.33 ms (i.e., 1000 ms/120) which is non-integer. The DRX on duration start position is in term of subframe or in term of ms as defined in the following formulas as defined in 3GPP specification TS 38.321.

$$[ ( SFN \times 10 ) + subframe number ] modulo ( drx - ShortCycle ) = ( drx - StartOffset ) modulo ( drx - ShortCycle ) ; or \\ [ ( SFN \times 10 ) + subframe number ] modulo ( drx - LongCycle ) = drx - StartOffset .$$

For instance, RRC signalling may control a DRX operation by configuring the following parameters:
drx-LongCycleStartOf set: the Long DRX cycle and drx-StartOffet which defines the subframe where the Long and Short DRX Cycle starts; and/or
drx-ShortCycle (optional): the Short DRX cycle.

As defined in 3GPP Rel-15 or Rel-16, configurable connected DRX (CDRX) long cycle values are 10 ms, 20 ms, 32 ms, 40 ms, and etc. and configurable CDRX short cycle values are 2 ms, 3 ms, 5 ms, 6 ms, 7 ms, 8 ms, 10 ms, 14 ms, 16 ms, 20 ms, 30 ms, 32 ms, 35 ms, and etc.

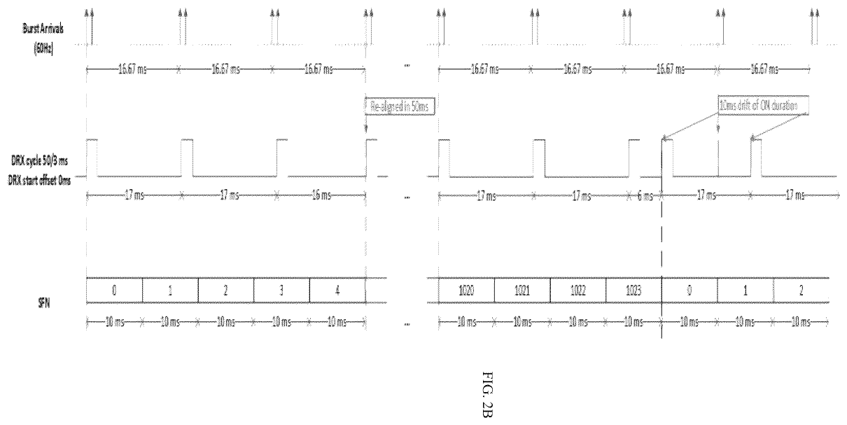

FIGS. 2A and 2B illustrate exemplary schematic diagrams of non-integer periodicity of XR traffic in accordance with some embodiments of the subject application.

Referring to FIG. 2A, XR traffic bursts may be of 60 fps, of which a frame periodicity is 16.67 ms. Four XR traffic bursts with three frame periodicities occupy 50 ms in the time domain. In some embodiments, a DRX cycle with the length of 16 ms may be used. However, using 16 ms DRX cycles will cause that the last XR traffic burst misses the on-duration time of a DRX cycle, because three 16 ms DRX cycles occupy 48 ms in the time domain, which is less 2 ms. That is, the traffic misses the on-duration time of the DRX cycle. In some other embodiments, a DRX cycle with the length of 17 ms may be used. However, using 17 ms DRX cycles also has a problem that it will cause extra latency for waiting for the on-duration time of the DRX cycle. Thus, there is a DRX issue of XR traffic in the embodiments as shown in FIG. 2A.

Referring to FIG. 2B, there may be a SFN wraparound mismatch issue between XR DL traffic (e.g., 60 fps) and a DRX start offset. Legacy DRX pattern is repeated every 10,240 ms, which is equal to a hyper frame period. A hyper frame includes 1024 SFNs, e.g., SFN 0 to SFN 1023. However, this hyper frame period cannot be divisible with XR periodicity. Therefore, the mismatch issue happens between the DRX on-duration time and XR DL traffic arrivals when SFN returns to 0 every hyper frame 10,240 ms. FIG. 2B shows the case of SFN wraparound mismatch of 60 fps XR DL traffic when the DRX start offset is set to 0. As shown in FIG. 2B, Burst Arrivals (60 Hz) are of a frame periodicity 16.67 ms. When using a DRX cycle 50/3 ms and DRX start offset 0 ms, each three DRX cycles may be of lengths of 17 ms, 17 ms and 16 ms, respectively, 10,240 ms=204×50 ms+40 ms. Accordingly, the last 40 ms within a hyper frame (i.e., SFN 1020, SFN 1021, SFN 1022, and SFN 1023 as shown in FIG. 2B) are divided into “17 ms+17 ms+6 ms”. At the end of the hyper frame (i.e., after 6 ms), the DRX on-duration time starts because SFN returns to 0 and subframe number is 0, but the actual XR DL traffic arrives 10 ms (i.e., 0.6 frame) later (after 16 ms). This mismatch issue would also lead to XR capacity loss due to larger latency and/or larger UE power consumption to keep the same latency performance.

In addition, there may be a variable arrival burst of XR traffic. For a XR service, DL traffic bursts are periodic with some time jitter in the arrival timing at a BS. The jitter may be due to a random delay contributed from frame encoders in an edge server, and/or network transferring time from a wireless system. This jitter may cause a tempo mismatch between the XR traffic and the CDRX cycle(s). A UE will increase the awaking time due to the late packet arrival. It is challengeable to schedule the DL data within a packet delay budget (PDB) for the BS due to the early packet arrival.

Moreover, some solutions propose to support an allocation of multiple resources to handle large-sized XR application packets. The multiple-slot scheduling may be used to avoid the multi-DCI transmissions. In this case, it is foreseen that the possibility to receive the PDCCH indicating a new UL/DL transmission or the retransmission before the end of the last transmission within the bundle is less. Therefore, some embodiments of the present application provide solutions for a UE to not start the inactivity timer and drx-RetransmissionTimer UL so early like legacy operation which may cause more power consumptions.

Given the above, embodiments of the present application design more efficient power saving mechanisms of a XR device. Embodiments of the present application aim to solve DRX related issues taking the XR traffic characteristics into account, including: how to solve the mismatch issue with the current DRX cycle and XR traffic arrival due to the non-integer periodicity of XR traffic; how to solve the mismatch issue with DRX cycle(s) and XR traffic arrival in case of SFN wrapround due to the hyper frame number (HFN) period (10240 ms) cannot be divisible by the XR period (e.g., 17 ms); how to dynamically monitor PDCCH considering the arrival timing with some jitter for power saving; and/or how to adapt DRX operation to the multiple-slot scheduling in single DCI for power saving.

More specifically, some embodiments of the subject application introduce mechanisms of overcoming non-integer periodicity of XR traffic. In some embodiments of the subject application, to enable more efficient DRX operation(s) for power saving of a XR device, a UE monitors a PDCCH transmission in a subset of the DRX-On-Duration according to the DRX-On-Duration bitmap indication via a semi-static configuration or a dynamic command. In some embodiments of the subject application, to enable more efficient DRX operation for power saving of XR device, the start timing of the drx-InactivityTimer and drx-RetransmissionTimerUL for the DRX group is delayed till the firstly appeared symbol in time domain after the end of the last transmission within the bundle of transport blocks (TBs) (not repetition) scheduled by the single DCI. In some embodiments of the subject application, to enable more efficient DRX operation for power saving of a XR device, the non-integer period DCP duration is in place of DRX-On-Duration.

More details will be illustrated in the following text in combination with the appended drawings. Persons skilled in the art should well know that the wording “a/the first,” “a/the second” and “a/the third” etc. are only used for clear description, and should not be deemed as any substantial limitation. e.g., sequence limitation.

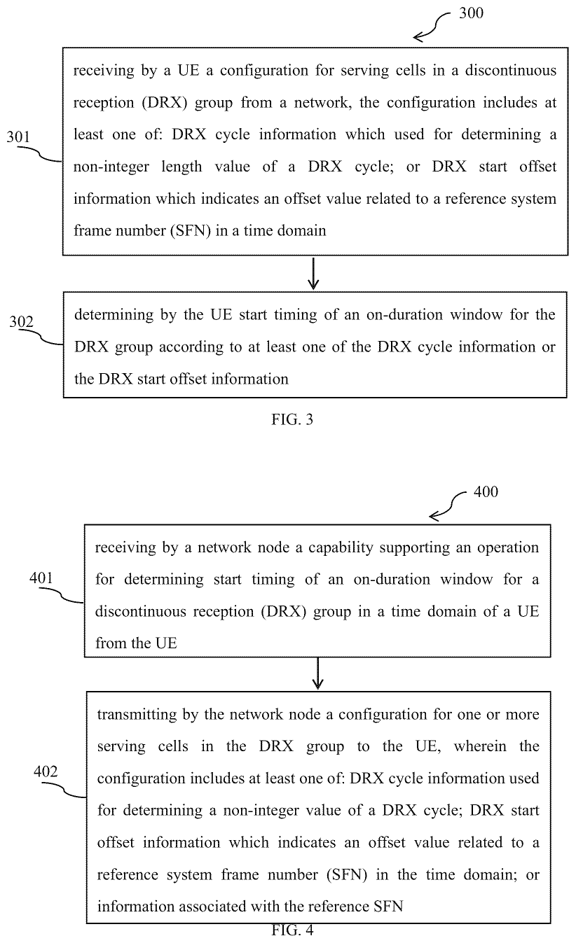

FIG. 3 illustrates an exemplary flowchart for receiving a configuration for a serving cell in a DRX group in accordance with some embodiments of the subject application. The exemplary method 300 in FIG. 3 may be performed by a UE. Although described with respect to a UE, it should be understood that other devices may be configured to perform a method similar to that of FIG. 3.

In the exemplary method 300 in FIG. 3, in operation 301, a UE (e.g., UE 102 as shown in FIG. 1) receives a configuration (denoted as first configuration for simplicity) for one or more serving cells in a DRX group from a network (e.g., BS 101 as shown in FIG. 1). The first configuration may include at least one of: DRX cycle information which used for determining a non-integer length value of a DRX cycle; or DRX start offset information which indicates an offset value related to a reference SFN in a time domain. In some embodiments, a unit is the offset value is associated with one of: a subframe, a slot, and a symbol.

In operation 302, the UE determines start timing (denoted as first start timing for simplicity) of an on-duration window for the DRX group according to at least one of the DRX cycle information or the DRX start offset information.

In some embodiments, the UE determines further start timing (denoted as second start timing for simplicity) of the on-duration window for the DRX group in the time domain according to at least one of the DRX cycle information or the DRX start offset information.

In some embodiments, the first configuration further includes information associated with the reference SFN, and at least one of the first start timing or the second start timing of the on-duration window is further determined according to the information associated with the reference SFN.

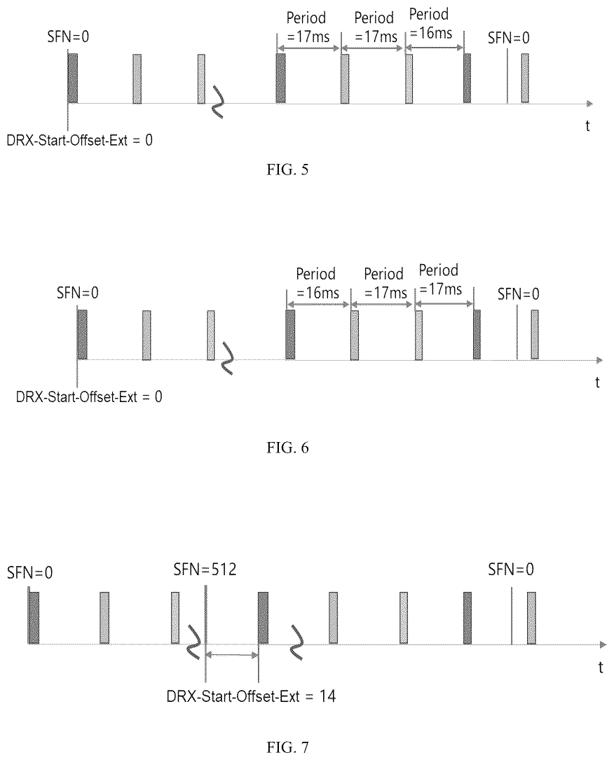

In some embodiments, the DRX cycle information includes a downlink (DL) frame rate in the time domain, and the non-integer length value is determined based on the DL frame rate. In some other embodiments, the DRX cycle information includes the non-integer length value. Specific examples are described in embodiments of FIGS. 5-7 as follows.

In some embodiments, the UE may receive a further configuration (denoted as second configuration for simplicity) for the one or more serving cells in the DRX group from the network. The second configuration indicates a subset of the on-duration window. The UE may monitor a PDCCH transmission in the subset of the on-duration window according to the second configuration.

In some embodiments, the second configuration includes at least one of:
(1) a bitmap indication (e.g., drx-On-Duration bitmap) associated with the on-duration window; or
(2) an information list (e.g., drx-On-Duration list) associated with one or more subsets of the on-duration window. In an embodiment, the information list indicates at least one of: start timing of a subset within the one or more subsets of the on-duration window; or a length of the subset within the one or more subsets of the on-duration window.

In some embodiments, at least one of the first start timing of the on-duration window, the second start timing of the on-duration window, or the start timing of the subset within the one or more subsets is: a start sub-frame, or a start slot, or a start symbol.

In some embodiments, the second configuration indicates which occasions in the time domain are needed for monitoring the PDCCH transmission in the subset of the on-duration window.

In some embodiments, the second configuration is received via RRC signalling (e.g., an RRC reconfiguration message) or a dynamic command (e.g., DCI or a MAC CE).

In some embodiments, the UE may transmit jitter range information to the network. The jitter range information includes at least one of: a UL jitter range of data arrival time at the UE; or a probability of the UL jitter range. Specific examples are described in embodiments of FIGS. 11-13 as follows.

In some embodiments, the UE may receive single downlink control information (DCI) used for scheduling multiple slots in the time domain for a downlink (DL) or an uplink (UL) of the UE from the network on a serving cell in the DRX group. Each slot within the multiple slots is corresponding to a unique hybrid automatic repeat request (HARQ) process of the UE.

In some embodiments, in response to the single DCI used for scheduling the multiple slots for the DL or the UL and in response to receiving a PDCCH transmission indicating a new DL or UL transmission within the multiple slots on the serving cell in the DRX group, the UE may not start a DRX inactivity timer for the DRX group, or the UE may delay start timing of the DRX inactivity timer for the DRX group till a firstly appeared symbol in the time domain after ending timing of a last PDSCH transmission within the multiple slots.

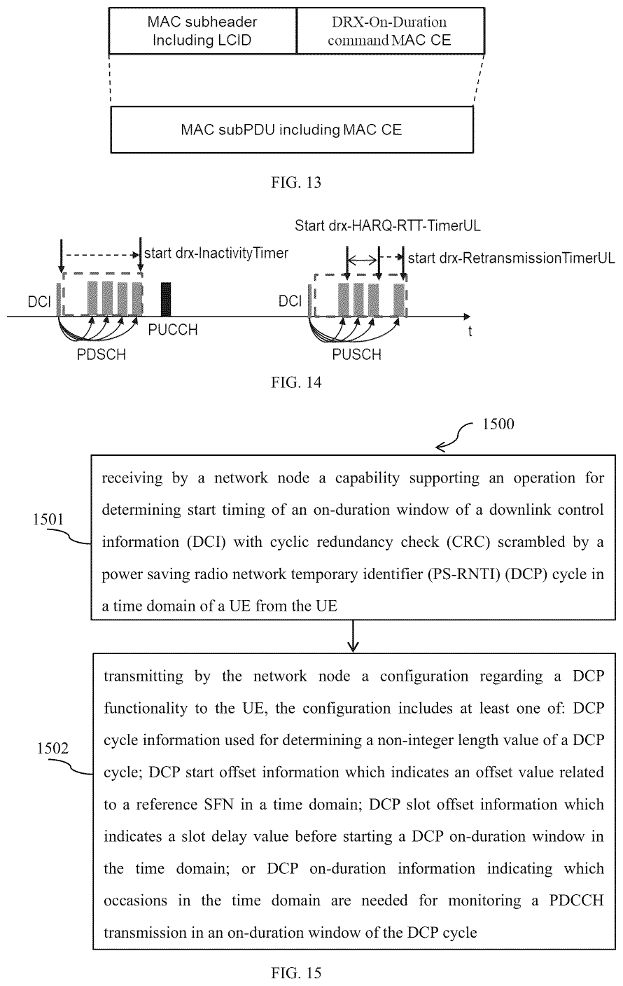

In some embodiments, in response to the single DCI used for scheduling the multiple slots for the UL and in response to an expiry of a DRX HARQ round trip time (RTU) timer for a PUSCH transmission within the multiple slots for a corresponding HARQ process, the UE may start a DRX retransmission timer for the UL for the corresponding HARQ process at later timing between: a firstly appeared symbol in the time domain after the expiry of the DRX HARQ RTT timer for the UL; and a firstly appeared symbol in the time domain after ending timing of a last PUSCH transmission within the multiple slots. A specific example is described in embodiments of FIG. 14 as follows.

FIG. 4 illustrates an exemplary flowchart for transmitting a configuration for a serving cell in a DRX group in accordance with some embodiments of the subject application. The exemplary method 400 in FIG. 4 may be performed by a network node, e.g., a BS. Although described with respect to a BS, it should be understood that other devices may be configured to perform a method similar to that of FIG. 4.

In the exemplary method 400 in FIG. 4, in operation 401, a network node (e.g., BS 101 as shown in FIG. 1) receives from a UE (UE 102 as shown in FIG. 1) a capability supporting an operation for determining start timing of an on-duration window for a DRX group in a time domain of the UE. In operation 402, the network node transmits a configuration for one or more serving cells in the DRX group to the UE. The configuration may include at least one of:
(1) DRX cycle information used for determining a non-integer value of a DRX cycle;
(2) DRX start offset information (e.g., DRX-Start-Offset-Ext) which indicates an offset value related to a reference SFN in the time domain; or
(3) information associated with the reference SFN.

In some embodiments, the start timing of the on-duration window is a start sub-frame or a start slot or a start symbol.

It should be appreciated by persons skilled in the art that the sequence of the operations in exemplary procedure 300 or 400 may be changed and that some of the operations in exemplary procedure 300 or 400 may be eliminated or modified, without departing from the spirit and scope of the disclosure. Details described in all other embodiments of the present application are applicable for the embodiments of any of FIGS. 3 and 4. Moreover, details described in the embodiments of any of FIGS. 3 and 4 are applicable for all the embodiments of FIGS. 1-2B and 5-18.

FIGS. 5-7 illustrate exemplary schematic diagrams of supporting a non-integer DRX cycle in accordance with some embodiments of the subject application.

FIG. 5 shows embodiments of DRX-Start-Offset-Ext=0, XR DL frame rate=60 fps, and DRX cycle length=1000/60 ms (i.e., 16.67 ms which is non-integer). For instance, the DRX start offset (i.e., DRX-Start-Offset-ExC) is 0 as shown in FIG. 5. In these embodiments, a UE may determine the N*^{h} start position of the DRX-On-Duration based on the non-integer DRX cycle and the DRX-Start-Offset-Ext relative to a reference SFN (e.g., SFN 0). In these embodiments, the UE may determine that the DRX pattern is 0, 17 ms, 34 ms (i.e., 17 ms+17 ms), 50 ms (i.e., 17 ms+17 ms+16 ms), and etc., in a case of XR DL frame rate is 60 fps.

For instance, in the embodiments of FIG. 5, a BS may send DRX configuration(s) to the UE which includes:
(1) DRX-Start-Offset-Ext, which indicates an offset value related to the time reference SFN=0. Unit is a subframe. A subframe is 1 ms. In different embodiments, a subframe may include 1 slot, 2 slots, 4 slots, or etc.
(2) Non-integer DRX cycle, which has a non-integer value that indicates real cadences of traffic. Unit is ms.
   a) This may be composed of 2 parameters (X, Y). Sample Y times every X duration.
   b) This may be only 1 parameter “X/Y”.
      (a) For a frame rate=60 fps, DRX cycle length=1000/60 ms.
      (b) For a frame rate=30 fps, DRX cycle length=1000/30 ms.
      (c) For a frame rate=90 fps, DRX cycle length=1000/90 ms.
(3) drx-onDurationTimer: the duration at the beginning of a DRX cycle. The drx-onDurationTimer may also be named as “DRX On Duration Window” or “DRX-On-Duration” or the like.
(4) drx-SlotOffset: the delay before starting the drx-onDuratonTimer.
(5) drx-InactivityTimer: the duration after the PDCCH occasion in which a PDCCH indicates a new UL or DL transmission for the MAC entity of the UE.
(6) drx-RetransmissionTimerDL (per DL HARQ process except for the broadcast process): the maximum duration until a DL retransmission is received.
(7) drx-RetransmissionTimerUL (per UL HARQ process): the maximum duration until a grant for an UL retransmission is received.

In the embodiments of FIG. 5, the DRX configuration(s) received by the UE may include the non-integer value of the DRX cycle length configuration. The MAC entity of the UE shall consider sequentially that the Nm (N>=0) DRX-On-Duration start position occurs in the subframe for which:

$$[ ( SFN \times 10 ) + subframe number ] = ceil ( DRX - Start - Offset - Ext + N \times Non - integer DRX cycle ) modulo ( 1024 \times 10 ) \qquad Formula ( 1 )$$

Then, the MAC entity of the UE may start drx-onDurationTimer for this DRX group after drx-SlotOffset from the beginning of the subframe.

FIG. 6 shows further embodiments of DRX-Start-Offset-Ext=0, XR DL frame rate=60 fps, and DRX cycle length=1000/60 ms (i.e., 16.67 ms which is non-integer). For instance, the DRX start offset is 0 as shown in FIG. 6. In these embodiments, a UE may determine that the DRX pattern is 0, 16 ms, 33 ms (i.e., 16 ms+17 ms), 50 ms (i.e., 16 ms+17 ms+17 ms), and etc. in a case of frame rate is 60 fps.

For instance, in the embodiments of FIG. 6, a BS may send DRX configuration(s) identical with or similar to the abovementioned DRX configuration(s) in the embodiments of FIG. 5 to the UE. In the embodiments of FIG. 6, the DRX configuration(s) received by the UE may include the non-integer value of the DRX cycle length configuration. The MAC entity of the UE shall consider sequentially that the N^{h} (N>=0) DRX-On-Duration start position occurs in the subframe for which:

$$[ ( SFN \times 10 ) + subframe number ] = floor ( DRX - Start - Offset - Ext + N \times Non - integer DRX cycle ) modulo ( 1024 \times 10 ) \qquad Formula ( 2 )$$

Then, the MAC entity of the UE may start drx-onDurationTimer for this DRX group after drx-SlotOffset from the beginning of the subframe.

FIG. 7 shows additional embodiments of DRX-Start-Offset-Ext=0, XR DL frame rate=60 fps, and DRX cycle length=1000/60 ms (i.e., 16.67 ms which is non-integer). In these embodiments, a BS may configure timeReferenceSFN to 512, and DRX-Start-Offset-Ext is related to the time reference SFN (i.e., 512). For instance, the DRX start offset is 14 as shown in FIG. 7. A UE may determine the DRX start position according to the timeReferenceSFN (i.e., 512) and DRX-Start-Offset-Ext (i.e., 14). The BS may send DRX configuration(s) to the UE which includes:
(1) timeReferenceSFN=512
(2) DRX-Start-Offset-Ext which indicates an offset value related to the reference SFN=512.

Similar to the embodiments of FIGS. 5 and 6, in the embodiments of FIG. 7, the MAC entity of the UE shall consider sequentially that the N^{th} (N>=0) DRX-On-Duration start position occurs in the subframe for which:

$$[ ( SFN \times 10 ) + subframe number ] = ceil ( timeReferenceSFN \times 10 + DRX - Start - Offset - Ext + N \times Non - integer DRX cycle ) ) modulo ( 1024 \times 10 ) ; or \qquad Formula ( 3 )$$

$$[ ( SFN \times 10 ) + subframe number ] = floor ( timeReferenceSFN \times 10 + DRX - Start - Offset - Ext + N \times Non - integer DRX cycle ) modulo ( 1024 \times 10 ) \qquad Formula ( 4 )$$

Then, the MAC entity of the UE may start drx-onDurationTimer for this DRX group after drx-SlotOffset from the beginning of the subframe.

FIGS. 5-7 illustrate embodiments supporting a non-integer DRX cycle which consider DRX-Start-Offset-Ext of the DRX-On-Duration with the granularity of a subframe. In some additional embodiments of the subject application supporting a non-integer DRX cycle, more granular DRX-Start-Offset-Ext of the DRY-On-Duration may be considered, for example, the unit is a slot. The MAC entity of the UE shall consider sequentially that the N^{th} (N>=0) start position of DRX-On-Duration occurs in the slot for which:

$$[ ( SFN \times numberOfSlotsPerFrame ) + slot number in the frame ] = ceil ( timeReferenceSFN \times numberOfSlotsPerFrame + DRX - Start - Offset - Ext + N \times Non - integer DRX cycle \times numberOfSlotsPerSubFrame ) modulo ( 1024 \times numberOfSlotsPerFrame ) ; or \qquad Formula ( 5 )$$

$$[ ( SFN \times numberOfSlotsPerFrame ) + slot number in the frame ] = floor ( timeReferenceSFN \times numberOfSlotsPerFrame + DRX - Start - Offset - Ext + N \times Non - integer DRX cycle \times numberOfSlotsPerSubFrame ) ) modulo ( 1024 \times numberOfSlotsPerFrame ) \qquad Formula ( 6 )$$

Then, the MAC entity of the UE may start drx-onDurationTimer for this DRX group from the beginning of the slot.

In yet additional embodiments of the subject application supporting a non-integer DRX cycle, more granular DRX-Star-O/set-Ext of the DRX-On-Duration may be considered, for example, the unit is a symbol. The MAC entity of the UE shall consider sequentially that the N^{th} (N>=0) DRX-On-Duration start position occurs in the symbol for which:

$$[ ( SFN \times numberOfSlotsPerFrame \times numberOfSymbolsPerSlot ) + slot number in the frame \times numberOfSymbolsPerSlot + symbol number in the slot ] = ceil ( timeReferenceSFN \times numberOfSlotsPerFrame \times numberOfSymbolsPerSlot + DRX - Start - Offset - Ext + N \times Non - integer DRX cycle \times numberOfSLotsPerSubFrame \times numberOfSymbolsPerSlot ) modulo ( 1024 \times numberOfSlotsPerFrame \times numberOfSymbolsPerSlot ) ; or \qquad Formula ( 7 )$$

$$[ ( SFN \times numberOfSlotsPerFrame \times \qquad Formula ( 8 )$$

$$numberOfSymbosPerSlot ) + slot number in the frame \times$$

$$numberOfSymbolsPerSlot + symbol number in the slot ] =$$

$$floor ( timeReferenceSFN \times numberOfSlotsPerFrame \times$$

$$numberOfSymbolsPerSlot + DRX - Start - Offset - Ext + N \times$$

$$Non - integer DRX cycle \times numberOfSlotsPerSubFrame \times$$

$$numberOfSymbolsPerSlot ) modulo ( 1024 \times numberOfSlotsPerFrame \times$$

$$numberOfSymbolsPerSlot )$$

Then, the MAC entity of the UE may start drx-onDurationTimer for this DRX group from the beginning of the symbol number.

In yet additional embodiments of the subject application supporting a non-integer DRX cycle, in a case of a BS CU-DU split, BS-CU may send non-integer DRX cycle information to BS-DU in F1AP message (e.g., UI CONTEXT SETUP REQUEST message, or UE CONTEXT MODIFICATION REQUEST message), so that BS-DU may determine the DRX-On-Duration pattern for a DRX group according the non-integer DRX cycle information.

In an embodiment. Non-integer DRX cycle information element (IE) may be added in the DRX Cycle IE, e.g., as shown in Table 1.

TABLE 1

| IE/Group Name | IE Type and Reference | Semantics Description |
|---|---|---|
| Non-integer DRX | ENUMERATED | This IE is defined in TS |
| Cycle Length | (ms1000/60, | 38.331 [8] |
| | ms1000/120, . . . ) | |

In a further embodiment, a value range of Long DRX Cycle Length IE or Short DRX Cycle Length IE may be extended to include the non-integer value of the non-integer DRX cycle, e.g., as shown in Table 2.

TABLE 2

| IE/Group | | Semantics |
|---|---|---|
| Name | IE Type and Reference | Description |
| Long DRX | ENUMERATED | This IE is |
| Cycle | (ms10, ms20, ms32, ms40, ms60, ms64, | defined in |
| Length | ms70, ms80, ms128, ms160, ms256, | TS 38.331 [8] |
| | ms320, ms512, ms640, ms1024, | |
| | ms1280, ms2048, ms2560, ms5120, | |
| | ms10240, . . . , ms1000/60, ms1000/120) | |
| Short DRX | ENUMERATED | This IE is |
| Cycle | (ms2, ms3, ms4, ms5, ms6, ms7, ms8, | defined in |
| Length | ms10, ms14, ms16, ms20, ms30, ms32, | TS 38.331 [8] |
| | ms35, ms40, ms64, ms80, ms128, | |
| | ms160, ms256, ms320, ms512, | |
| | ms640, . . . , ms1000/60, ms1000/120) | |

Details described in all other embodiments of the present application are applicable for the embodiments of any of FIGS. 5-7. Moreover, details described in the embodiments of any of FIGS. 5-7 are applicable for all the embodiments of FIGS. 1-4 and 8-18.

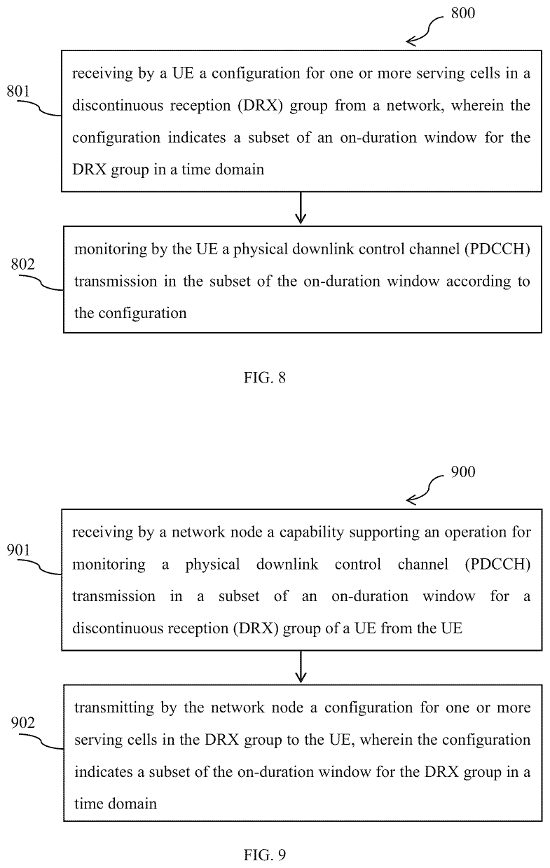

FIG. 8 illustrates an exemplary flowchart for receiving a configuration for a serving cell in a DRX group in accordance with some embodiments of the subject application. The exemplary method 800 in FIG. 8 may be performed by a UE. Although described with respect to a UE, it should be understood that other devices may be configured to perform a method similar to that of FIG. 8.

In the exemplary method 800 in FIG. 8, in operation 801, a UE (e.g., UE 102 as shown in FIG. 1) receives a configuration (denoted as first configuration for simplicity) for one or more serving cells in a DRX group from a network (e.g., BS 101 as shown in FIG. 1). The configuration indicates a subset of an on-duration window for the DRX group in a time domain. In operation 802, the UE monitors a PDCCH transmission in the subset of the on-duration window according to the configuration.

In some embodiments, the configuration includes at least one of: a bitmap indication (e.g., drx-On-Duration bitmap) associated with the on-duration window; or an information list (e.g., drx-On-Duration list) associated with one or more subsets of the on-duration window. In an embodiment, the information list indicates at least one of: start timing of a subset within the one or more subsets of the on-duration window; or a length of the subset within the one or more subsets of the on-duration window.

In some embodiments, the configuration indicates which occasions in the time domain are needed for monitoring the PDCCH transmission in the subset of the on-duration window. Specific examples are described in embodiments of FIGS. 5-7 as follows.

In some embodiments, the UE may receive information (denoted as first information for simplicity) associated with a DRX on-duration window length from the network, receive DRX slot offset information which indicates a slot delay value before starting the DRX on-duration window in the time domain from the network; receive information (denoted as second information for simplicity) associated with the DRX cycle and a start offset value of the DRX cycle in the time domain from the network, and determine start timing (denoted as first start timing for simplicity) of the on-duration window for the DRX group in the time domain according to at least one of the first information, the DRX slot offset information, or the second information. In an embodiment, the UE may determine start timing (denoted as second start timing for simplicity) of the on-duration window in the time domain according to at least one of the first information, the DRX slot offset information, or the second information.

In some embodiments, the UE may receive a configuration (denoted as first configuration for simplicity) for the one or more serving cells in the DRX group from the network. The first configuration includes at least one of: DRX cycle information used for determining a non-integer length value of a DRX cycle; or DRX start offset information which indicates an offset value related to a reference system frame number (SFN) in the time domain. In some embodiments, a unit is the offset value is associated with one of: a subframe, a slot, and a symbol. The UE may determine the first start timing of the on-duration window for the DRX group in the time domain according to at least one of the DRX cycle information or the DRX start offset information. In an embodiment, the UE may determine the second start timing of the on-duration window in the time domain according to at least one of the DRX cycle information or the DRX start offset information.

In some embodiments, at least one of the start timing of the subset within the one or more subsets, the first start timing of the on-duration window, or the second start timing of the on-duration window is: a start sub-frame, or a start slot, or a start symbol.

In some embodiments, the first configuration further includes information associated with the reference SFN, and the start timing of the on-duration window is further determined according to the information associated with the reference SFN.

In some embodiments, the DRX cycle information includes a DL frame rate in the time domain, and the non-integer length value is determined based on the DL frame rate. In some other embodiments, the DRX cycle information includes the non-integer length value. Specific examples are described in embodiments of FIGS. 5-7 as follows.

In some embodiments, the UE may transmit jitter range information to the network. The jitter range information includes at least one of: a UL jitter range of data arrival time at the UE; or a probability of the UL jitter range.

In some embodiments, the UE may receive single DCI used for scheduling multiple slots in the time domain for a DL or a UL of the UE from the network on a serving cell in the DRX group. Each slot within the multiple slots is corresponding to a unique HARQ process of the UE.

In some embodiments, in response to the single DCI used for scheduling the multiple slots for the DL or the UL and in response to receiving a PDCCH transmission indicating a new DL or UL transmission within the multiple slots, the UE may not start a DRX inactivity timer for the DRX group, or the UE may delay start timing of the DRX inactivity timer for the DRX group till a firstly appeared symbol in the time domain after ending timing of a last DSCH transmission within the multiple slots.

In some embodiments, in response to the single DCI used for scheduling the multiple slots for the UL and in response to an expiry of a DRX hybrid automatic repeat request (HARQ) round trip time (RTT) timer for a physical uplink share channel (PUSCH) transmission within the multiple slots for a corresponding HARQ process, the UE may start a DRX retransmission timer for the UL for the corresponding HARQ process at later timing between: a firstly appeared symbol in the time domain after the expiry of the DRX HARQ RTT timer for the UL; and a firstly appeared symbol in the time domain after ending timing of a last PUSCH transmission within the multiple slots. A specific example is described in embodiments of FIG. 14 as follows.

FIG. 9 illustrates an exemplary flowchart for transmitting a configuration for a serving cell in a DRX group in accordance with some embodiments of the subject application. The exemplary method 900 in FIG. 9 may be performed by a network node, e.g., a BS. Although described with respect to a BS, it should be understood that other devices may be configured to perform a method similar to that of FIG. 9.

In the exemplary method 900 in FIG. 9, in operation 901, a network node (e.g., BS 101 as shown in FIG. 1) receives from a UE (UE 102 as shown in FIG. 1) a capability supporting an operation for monitoring a PDCCH transmission in a subset of an on-duration window for a DRX group of the UE. In operation 902, the UE transmits a configuration for one or more serving cells in the DRX group to the UE. The configuration indicates a subset of the on-duration window for the DRX group in a time domain. Specific examples are described in embodiments of FIGS. 11-13 as follows.

In some embodiments, the configuration indicates which occasions in the time domain are needed for monitoring the PDCCH transmission in the subset of the on-duration window.

In some embodiments, the configuration is transmitted via RRC signalling (e.g., an RRC reconfiguration message) or a dynamic command (e.g., DCI or a MAC CE).

In some embodiments, the network node may receive jitter range information from the UE or a core network (CN). The jitter range information may include at least one of:
(1) a DL jitter range of data arrival time at the network node;
(2) a UL jitter range of data arrival time at the UE;
(3) a probability of the DL jitter range; or
(4) a probability of the UL jitter range.

It should be appreciated by persons skilled in the art that the sequence of the operations in exemplary procedure 800 or 900 may be changed and that some of the operations in exemplary procedure 800 or 900 may be eliminated or modified, without departing from the spirit and scope of the disclosure. Details described in all other embodiments of the present application are applicable for the embodiments of any of FIGS. 8 and 9. Moreover, details described in the embodiments of any of FIGS. 8 and 9 are applicable for all the embodiments of FIGS. 1-7 and 10-18.

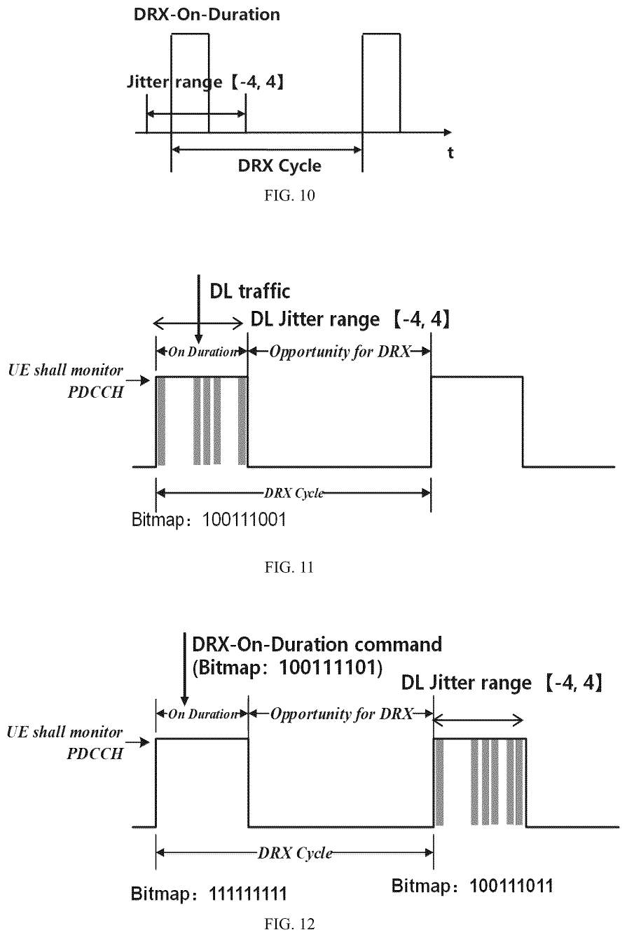

FIG. 10 illustrates an exemplary diagram of a XR traffic arrival with a jitter range in accordance with some embodiments of the subject application. As shown in FIG. 10, DRX-On-Duration within a DRX cycle may have a jitter range, e.g., [−4, 4] ms. [−4, 4] ms may also be represented as [−4 ms, 4 ms] or the like. Each endpoint value of the jitter range may vary according to different embodiments, without departing from the spirit and scope of the disclosure. The jitter range may also be named as a DL jitter range or the like.

FIGS. 11 and 12 illustrate exemplary schematic diagrams for a sparse DRX on-duration set by a bitmap in accordance with some embodiments of the subject application. As shown in FIGS. 11 and 12, a UE shall monitor a PDCCH transmission at the start of DRX-On-Duration in a DRX cycle. One DRX cycle includes “On Duration” and “Opportunity for DRX”. Similar to the embodiments of FIG. 10, the DL jitter range in the embodiments of FIGS. 11 and 12 is also [−4, 4] ms. In the embodiments of FIGS. 11 and 12, a PDCCH transmission may be monitored on the DRX-On-Duration according to DRX-On-Duration bitmap. For example, a UE only monitors a subset of the DRX-On-Duration according to the DRX-On-Duration bitmap.

In the embodiments of FIG. 11 or FIG. 12, a BS may receive a separate DL/UL jitter range from the CN or an application layer of the BS. For instance, a jitter ranger list may include one or more jitter ranges (for example, including following 3 jitter ranges) and the corresponding probability levels. Each jitter range may indicate the arrival jitter range relative to the configured periodical arrival time. Each probability level corresponding the jitter range may indicate a probability associated with the jitter range. A probability level may be of (0, 1). The higher probability level may present the higher possibilty. A probability level may be indicated by ‘high’, ‘middle’ or ‘low’ value, instead of the number value. In an embodiment, a jitter ranger list includes 3 jitter ranges and the corresponding probability levels:
(1) Jitter range [0, 3] ms
   Probability level=0.5
(2) Jitter range [−4, 0] ms
   Probability level=0.3
(3) Jitter range [3, 4] ms
   Probability level=0.9

In the embodiments of FIG. 11, the BS may send the DRX configuration(s) to the UE in an RRC reconfiguration message. The DRX configuration(s) may include at least one of:
(1) drx-onDurationTimer which indicates the duration at the beginning of a DRX cycle;
(2) drx-LongCycleStartOffset: the Long DRX cycle and drx-StartOffset which defines the subframe where the Long and Short DRX cycle starts;
(3) DRXShortCycle: the Short DRX Cycle:
(4) Non-integer DRX cycle: a non-integer value that indicates real cadences of traffic;
(5) DRX-Start-Offset-Ext: an offset value related to the time reference SFN;
(6) timeReferenceSFN: system SFN used as the reference to the DRX-Start-Offset-Ext;
(7) drx-SlotOffset which indicates the delay before starting the drx-onDurationTimer;
(8) drx-On-Duration bitmap which indicates which PDCCH monitoring occasion(s) (e.g., subframe, slot, or symbol) are needed for PDCCH monitoring on DRX-On-Duration. For example, the drx-On-Duration bitmap is 100111001, as shown in FIG. 11. For instance:
   a) The first/leftmost bit of this bitmap corresponds to the first subframe on the DRX-On-Duration.
   b) Value 0 in this bitmap indicates that the corresponding subframe is not allowed for PDCCH monitoring.
   c) Value 1 in this bitmap indicates that the corresponding subframe is allowed for PDCCH monitoring.

In the embodiments of FIG. 11, after receiving the DRX configuration(s), the UE may determine the PDCCH monitoring occasion(s) on the DRX-On-Duration according to value 1 in the drx-On-Duration bitmap. In some embodiments, the UE may determine the periodical start possion of the DRX-On-Duration according to existing technologies (e.g., 3GPP specification TS 38.321 vg70). In some other embodiments, the UE may determine the periodical start possion of the DRX-On-Duration according to any of the abovementioned embodiments related to a non-integer length value of a DRX cycle of the subject application. The UE may start drx-onDurationTimer for this DRX group. Then, the UE may determine the inner PDCCH monitoring pattern of the DRX-On-Duration according to the drx-On-Duration bitmap.

If the UE receives a new PDCCH transmission (DL or UL) on a serving cell in this DRX group, the UE may start the DRX in the inner pattern of the DRX-On-Duration according to the drx-On-Duration bitmap. The UE may start or restart drx-InactivityTimer for this DRX group in the firstly appeared symbol in time domain after the end of the PDCCH reception.

In the embodiments of FIG. 12, a BS may send a DRX-On-Duration command associated with drx-On-Duration bitmap via DCI or a MAC CE. A specific example of the MAC CE is described in embodiments of FIG. 13 as follows.

The DRX-On-Duration command may indicate which PDCCH occasion(s) (e.g., subframe, slot, or symbol) are needed for PDCCH monitoring on DRX-On-Duration.

For instance:
(1) The first/leftmost bit in drx-On-Duration bitmap corresponds to the firstly appeared subframe in time domain in the DRX-On-Duration.
(2) Value 0 in the bitmap indicates that the corresponding subframe is not allowed for PDCCH monitoring.
(3) Value 1 in the bitmap indicates that the corresponding subframe is allowed for PDCCH monitoring. For example, the bitmap in the DRX-On-Duration command is 100111011, as shown in FIG. 12.

After the UE receives the DRX-On-Duration command via DC or MAC CE, the UE may:
(1) apply the DRX-On-Duration command from the start of the DRX-On-Duration in the current DRX cycle; or
(2) apply the DRX-On-Duration command from the start of the DRX-On-Duration in a next DRX cycle. For example, as shown in FIG. 12, during On Duration of DRX Cycle of bitmap 111111111, the UE may receive a DRX-On-Duration command including the bitmap 100111011; and then, the UE may apply the DRX-On-Duration command from the start of DRX-On-Duration in the next DRX cycle which is of the DL jitter range [−4, 4] ms.

FIGS. 11 and 12 illustrate embodiments for PDCCH monitoring in which each bit in drx-On-Duration bitmap corresponds to the granularity of a subframe. In some additional embodiments of the subject application, a PDCCH transmission may be monitored on DRX-On-Duration according to drx-On-Duration bitmap, with each bit corresponding to the granularity of a slot. That is, the drx-On-Duration bitmap field may be used to indicate slot(s) that are needed for PDCCH monitoring on DRX-On-Duration. For example:
(1) The first/leftmost bit in the bitmap corresponds to the first slot on the DRX-On-Duration.
(2) Value 0 in the bitmap indicates that the corresponding slot is not allowed for PDCCH monitor.
(3) Value 1 in the bitmap indicates that the corresponding slot is allowed for PDCCH monitor.

In some embodiments of the subject application in which a PDCCH transmission may be monitored on the DRX-On-Duration according to a list of start offset value plus a length value, a UE only monitor a subset of the DRX-On-Duration according to the list of start offset value plus the length value, instead of according to the drx-On-Duration bitmap in the embodiments of FIGS. 11 and 12 as described above. For example, the list (e.g., drx-On-Duration list) may include three items:
(1) A start offset of the first item indicates that the UE starts the PDCCH monitoring at the offset relative to the beginning of the DRX-On-Duration. For example, the value is 0 ms.
   Length of the first item indicates the time length of the PDCCH monitoring. For example, the value is 1 ms.
(2) A start offset of the second item indicates that the UE starts the PDCCH monitoring at the offset relative to the beginning of the DRX-On-Duration. For example, the value is 3 ms.
   Length of the second item indicates the time length of the PDCCH monitoring. For example, the value is 3 ms.
(3) A start offset of the third item indicates that the UE starts the PDCCH monitoring at the offset relative to the beginning of the DRX-On-Duration. For example, the value is 9 ms.
   Length of the third item indicates the time length of the PDCCH monitoring. For example, the value is 1 ms.

Specifically, with reference to FIG. 11, in some embodiments, the BS may send the DRX configuration(s) to the UE in an RRC Reconfiguration message, and the DRX configuration(s) includes at least one of:
(1) drx-onDurationTimer which indicates the duration at the beginning of a DRX cycle;
(2) drx-SlotOffset which indicates the delay before starting the drx-onDurationTimer;
(3) drx-On-Duration list which indicates one or more periods that are needed for PDCCH monitoring on DRX-On-Duration. The item size of this list can be greater than or equals to 1. Each item of the list may include at least one of:
   (a) a start offset which indicates the UE to start the PDCCH monitoring at the offset relative to the beginning of the DRX-On-Duration; or
   (b) a length which indicates the UE to keep monitoring for the time length. The default value of the length may be 1 ms.

In some embodiments, in case of BS CU-DU split case, a CU may send “a bitmap indication associated with DRX-On-Duration” or “an information list associated with one or more subsets of the DRX-On-Duration” to the DU, which assists the DU to configure drx-On-Duration bitmap or drx-On-Duration list. In some embodiments, the CU may recommend which PDCCH monitoring occasion(s) (e.g., subframe, slot, or symbol) are needed for PDCCH monitoring on DRX-On-Duration for the DU and send it to the DU as reference. For instance:
(1) the CU may recommend the drx-On-Duration list for the DU and send it to the DU as reference, or
(2) the CU may recommend the drx-On-Duration bitmap for the DU and send it to the DU as reference. In an embodiment, the CU may send a jitter range list to the DU, which assists the DU to configure the drx-On-Duration bitmap.

After receiving the DRX configuration(s), the UE may determine the PDCCH monitoring occasion(s) on the DRX-On-Duration according to the drx-On-Duration list information in the DRX configuration(s).

In the embodiments, the BS may send a DRX-On-Duration command associated with drx-On-Duration list via DCI or a MAC CE. A specific example of the MAC CE is described in embodiments of FIG. 13 as follows. For instance, the DRX-On-Duration command MAC CE includes drx-On-Duration list which indicates one or more periods that are needed for PDCCH monitoring on DRX-On-Duration. The item size of this list can be greater than or equals to 1. Each item of the list may include at least one of:
(1) a start offset which indicates the UE to start the PDCCH monitoring at the offset relative to the beginning of the DRX-On-Duration; or
(2) a length which indicates the UE to keep monitoring for the time length. The default value of the length may be 1 ms.

After the UE receives the DRX-On-Duration command via DCI or MAC CE, the UE may:
(1) apply the DRX-On-Duration command from the start of the DRX-On-Duration in the current DRX cycle; or
(2) apply the DRX-On-Duration command from the start of the DRX-On-Duration in a next DRX cycle.

FIG. 13 illustrates an exemplary diagram of a MAC subPDU in accordance with some embodiments of the subject application. In an exemplary case of a DRX-On-Duration command MAC CE, a BS may send this MAC CE and a MAC subheader in a MAC subPDU to a UE. In the embodiments of FIG. 13, in the MAC subPDU including MAC CE, a DRX-On-Duration command MAC CE may be fixed-size or variable-sized MAC CE. For example, the length the fixed-size MAC CE may be 8 bits or 16 bits.

As shown in FIG. 13, in the MAC subPDU including MAC CE, the MAC subheader may include at least one of:
(1) LCID: Logical Channel ID field, which identifies the type of the corresponding DRX-On-Duration command MAC CE.
(2) L: The Length field, which indicates the length of the variable-sized MAC CE in bytes. There is one L field per MAC subheader except for subheaders corresponding to fixed-sized MAC CEs. The size of the L field is indicated by the F field.
(3) F: The Format field, which indicates the size of the Length field. There is one F field per MAC subheader except for subheaders corresponding to fixed-sized MAC CEs. The size of the F field may be 1 bit. Value 0 of the F field indicates 8 bits of the Length field. Value 1 of the F field indicates 16 bits of the Length field.

FIG. 14 illustrates an exemplary diagram regarding a DRX timer in accordance with some embodiments of the subject application. The embodiments of FIG. 14 refer to delaying the start timing of drx-InactivityTimer and drx-RetransmissionTimerUL. In these embodiments, the start timing of drx-InactivityTimer and drx-RetransmissionTimerUL for the DRX group is delayed if the multi-slot scheduling is received in single DCI carried on a PDCCH transmission. The multi-slot scheduling in single DCI may be used for UL or DL. The multi-slot scheduling for a new transmission means that multiple initial transmission TBs (not repetition) are scheduled. The multi-slot scheduling for a retransmission means that multiple retransmission TBs (not repetition) are scheduled.

Some embodiments of FIG. 14 refer to the start timing of drx-InactivityTimer. In these embodiments, if the PDCCH transmission indicates a new transmission (DL or UL) on a serving cell in this DRX group, and if the new transmission is one of the multi-slot new transmissions indicated in one single DCI, the UE may:
(1) not start the drx-InactivityTimer for this DRX group upon receiving the PDCCH transmission for a new transmission; or
(2) delay the start timing of the drx-InactivityTimer for this DRX group till the firstly appeared symbol in time domain after the end of the last PDSCH transmission (within a bundle or a group of slots).

Some other embodiments of FIG. 14 refer to the start timing of drx-RetransmissionTimerUL. In these embodiments, if the PDCCH transmission indicates a UL transmission on a serving cell in this DRX group, and if the UL transmission is one of the multi-slot transmissions indicated in one single DCI, the UE may:
(1) start the drx-HARQ-RTT-TimerUL for the corresponding HARQ process in the firstly appeared symbol in time domain after the end of the first transmission (within a bundle) of the corresponding PUSCH transmission; and
(2) stop the drx-RetransmissionTimerUL for the corresponding HARQ process.

In these embodiments, if drx-HARQ-RTT-TimerUL expires, and if drx-HARQ-RTT-TimerUL for the corresponding HARQ process is associated with a multi-slot transmission indicated in the single DCI, the UE may start the drx-Retransmission TimerUL for the corresponding HARQ process at later timing within following two timings:
(1) In the firstly appeared symbol in time domain after the expiry of drx-HARQ-RTT-TimerUL.
(2) Till the firstly appeared symbol in time domain after the end of the last PUSCH transmission (within a bundle or a group of slots).

Details described in all other embodiments of the present application are applicable for the embodiments of any of FIGS. 11-14. Moreover, details described in the embodiments of any of FIGS. 11-14 are applicable for all the embodiments of FIGS. 1-10 and 15-18.

FIG. 15 illustrates an exemplary flowchart of a configuration regarding DCP functionality in accordance with some embodiments of the subject application. The exemplary method 1500 in FIG. 15 may be performed by a network node, e.g., a BS. Although described with respect to a BS, it should be understood that other devices may be configured to perform a method similar to that of FIG. 15.

In the exemplary method 1500 in FIG. 15, in operation 1501, a network node (e.g., BS 101 as shown in FIG. 1) receives a capability supporting an operation for determining start timing of an on-duration window of a DCP cycle in a time domain of a UE (UE 102 as shown in FIG. 1) from the UE. In some embodiments, the configuration is transmitted via RRC signalling (e.g., an RRC reconfiguration message) or a dynamic command (e.g., DCI or a MAC CE). In some embodiments, the start timing of the on-duration window is: a start sub-frame, or a start slot, or a start symbol.

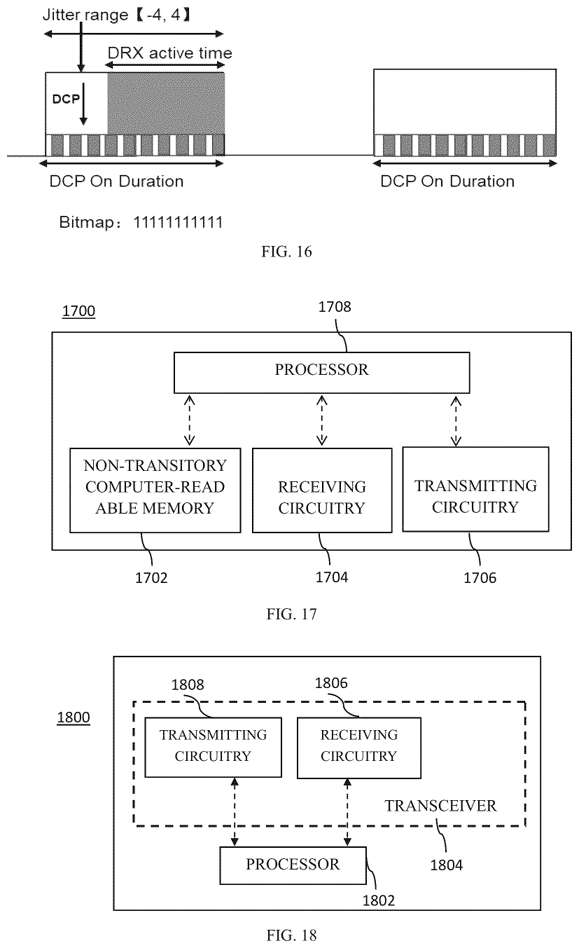

In operation 1502, the network node transmits a configuration regarding DCP functionality to the UE. A specific example is described in embodiments of FIG. 16 as follows. The configuration may include at least one of:
(1) DCP cycle information used for determining a non-integer length value of a DCP cycle:
(2) DCP start offset information (e.g., XCP-Start-Offset-&t) which indicates an offset value related to a reference SFN in time domain;
(3) DCP On Duration Window which indicates the duration at the beginning of a DCP cycle;
(4) DCP Slot Offset which indicates the delay before starting the DCP On Duration Window;
(5) DCP-LongCycleStartOffset: the Long DCP cycle and DCP Start Offset which defines the subframe where the Long and Short DCP Cycle starts;
(6) DCP ShortCycle: the Short DCP Cycle; or
(7) DCP on-duration information indicating which occasion(s) in the time domain are needed for monitoring a PDCCH transmission in an on-duration window of the DCP cycle. In some embodiments, the DCP on-duration information is a bitmap indication (e.g., drx-On-Duration bitmap) or an information list (e.g., drx-On-Duration list) associated with the on-duration window.

It should be appreciated by persons skilled in the art that the sequence of the operations in exemplary procedure 1500 may be changed and that some of the operations in exemplary procedure 1500 may be eliminated or modified, without departing from the spirit and scope of the disclosure. Details described in all other embodiments of the present application are applicable for the embodiments of FIG. 15. Moreover, details described in the embodiments of FIG. 15 are applicable for all the embodiments of FIGS. 1-14 and 16-18.

Some other embodiments of the subject application refer to an exemplary flowchart for receiving a configuration for a serving cell in a DRX group which may be performed by a UE. Although described with respect to a UE, it should be understood that other devices may be configured to perform a method similar to these embodiments. In this exemplary flowchart, a UE (e.g., UE 102 as shown in FIG. 1) receives a configuration regarding DCP functionality from a network (e.g., BS 101 as shown in FIG. 1). In some embodiments, the configuration may be received via RRC signalling (e.g., an RRC reconfiguration message) or a dynamic command (e.g., DCI or a MAC CE). The configuration may include at least one of:
(1) DCP cycle information used for determining a non-integer length value of a DCP cycle:
(2) DCP start offset information (e.g., DCP-Start-Often-Exit) which indicates an offset value related to a reference SFN in a time domain:
(3) DCP On-Duration Window which indicates the duration at the beginning of a DCP cycle:
(4) DCP Slot Offsets: the delay before starting the DCP On Duration Window:
(5) DCP-LongCycleStartOffset: the Long DCP cycle and DCP Start Offset which defines the subframe where the Long and Short DCP Cycle starts;
(6) DCP ShortCycle: the Short DCP Cycle; or
(7) DCP on-duration information indicating which occasion(s) in the time domain are needed for monitoring a PDCCH transmission in an on-duration window of the DCP cycle.

In some embodiments, the UE may determine start timing of an on-duration window of one DRX cycle in the time domain according to at least one of the DCP Slot Offset, the DCP cycle information, or the DCP start offset information. In an embodiment, the start timing of the on-duration window is a start sub-frame or a start slot or a start symbol.

In some embodiments, the UE may determine the N^{th} start position of the DCP-Duration based on the non-integer DCP cycle, DCP-Start-Offset and the DCP-Slot-offset. The DCP on duration start position is in term of subframe or in term of ms as defined in the following formulas.

$$[ ( SFN \times 10 ) + subframe number ] modulo ( DCP - ShortCycle ) = ( DCP - Start - Offset ) modulo ( DCP - ShortCycle ) ; or \qquad Formula ( 9 )$$

$$[ ( SFN \times 10 ) + subframe number ] modulo ( DCP - LongCycle ) = DCP - Start - Offset . \qquad Formula ( 10 )$$

Then, the MAC entity of the UE may start DCP-onDurationTimer after DCP-SlotOffset from the beginning of the subframe.

In some embodiments, the UE may monitor the PDCCH transmission in the on-duration window of the DCP cycle according to the DCP on-duration information. In an embodiment, the DCP on-duration information is a bitmap indication or an information list associated with the on-duration window. A specific example is described in embodiments of FIG. 16 as follows.

It should be appreciated by persons skilled in the art that the sequence of the operations in exemplary procedure 1500 may be changed and that some of the operations in exemplary procedure 1500 may be eliminated or modified, without departing from the spirit and scope of the disclosure. Details described in all other embodiments of the present application are applicable for the embodiments of FIG. 15. Moreover, details described in the embodiments of FIG. 15 are applicable for all the embodiments of FIGS. 1-14 and 16-18.

FIG. 16 illustrates an exemplary schematic diagram for a sparse DCP on-duration-time set by a bitmap in accordance with some embodiments of the subject application. The embodiments of FIG. 16 refer to non-integer period DCP duration in place of DRX-On-Duration. In the embodiments of FIG. 16, a UE may periodically monitor a DCP (DCI with CRC scrambled by PS-RNTI) command based on the non-integer DCP cycle and the DCP-Start-offset similar to the embodiments of the subject application as described above. The UE may start the PDCCH monitoring activity for the MAC entity's C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, and AT-RNTI, if the DCP command indicates to monitor the PCCCH transmission.

In the embodiments of FIG. 16, a BS may send DCP configuration(s) to the UE, which includes:
(1) PS-RNTI for indicating by which DCI with CRC scrambled. The PS-RNTI may be different from PS-RNTI as defined in 3GPP Rel-16.
(2) Search space ID which indicates a search space ID for acquiring the PS-RNTI scrambled PDCCH. This ID may be independent of a search space ID for acquiring the PDCCH of PS-RNTI as defined in 3GPP Rel-16.
(3) Size of DCI.
(4) DCP-onDurationTimer: the duration at the beginning of a DCP cycle. DCP-onDurationTimer may also be named as DCP-onDuration Window or DCP On Duration or the like.
(5) DCP Slot Offset: the delay before starting the DCP On Duration Window;
(6) DCP-Start-Offset: the subframe where the Long and Short DCP cycle starts;
(7) DCP-Start-Offset-Ext which indicates the offset related to the time reference SFN=0
(8) DCP-Non-integer cycle which has a non-integer value that indicates real cadences of traffic.
   For 60 fps, DCP-Non-integer cycle=1000/60 ms.
   For 30 fps, DCP-Non-integer cycle=1000/30 ms.
   For 90 fps, DCP-Non-integer cycle=1000/90 ms.
(9) DCP-On-Duration-bitmap for indicating which subframe(s) is needed for PDCCH monitoring on DCP-On-Duration-Time:
   The first/leftmost bit in this bitmap corresponds to the first subframe on the DRX-On-Duration-Time.
   Value 0 in this bitmap indicates that the corresponding subframe is not allowed for PDCCH monitoring.
   Value 1 in this bitmap indicates that the corresponding subframe is allowed for PDCCH monitoring.
(10) InactivityTimer: which indicates the duration after the PDCCH occasion in which a PDCCH indicates a new UL or DL transmission for the MAC entity.

In some embodiments, in case of BS CU-DU split case, the CU may recommend which PDCCH monitoring occasion(s) (e.g., subframe, slot, or symbol) are needed for PDCCH monitoring on DCP-On-Duration for the DU and send it to the DU as reference. For instance:
(1) the CU may recommend dcp-On-Duration list for the DU and send it to the DU as reference; or
(2) the CU may recommend dcp-On-Duration bitmap for the DU and send it to the DU as reference.

In the embodiments of FIG. 16, if the UE receives the DCP configuration(s) in the active bandwidth part (BWP), the UE may determine the N^{th start position of the DCP-Duration based on the non-integer DCP cycle and the DCP-Start-offset. For example, the determination formulas may be the same as any of Formulas (}1)-(8) as described above. In the embodiments of FIG. 16, if the UE is in DRX-inactivity time, the UE may monitor the DCP indication in the DCP-Duration. In some embodiments, the UE may receive the DCP command and determine to start the PDCCH monitoring activity for the MAC entity's C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, and AI-RNTI. In some embodiments, if the DCP indication received from a lower layer of the UE indicates the UE to enter to DRX active time, the UE may
(1) start InactivityTimer immediately after a minimum preparing gap; or
(2) start InactivityTimer after an offset, which may be indicated in the DCP indication or configured in the prior RRC message.

Details described in all other embodiments of the present application are applicable for the embodiments of FIG. 16. Moreover, details described in the embodiments of FIG. 16 are applicable for all the embodiments of FIGS. 1-15, 17 and 18.

FIG. 17 illustrates an exemplary block diagram of an apparatus 1700 for a power saving operation in accordance with some embodiments of the subject application. As shown in FIG. 17, the apparatus 1700 may include at least one non-transitory computer-readable medium 1702, at least one receiving circuitry 1704, at least one transmitting circuitry 1706, and at least one processor 1708 coupled to the non-transitory computer-readable medium 1702, the receiving circuitry 1704 and the transmitting circuitry 1706. The at least one processor 1708 may be a CPU, a DSP, a microprocessor etc. The apparatus 1700 may be a network node (e.g., a BS) or a UE configured to perform a method illustrated in the above or the like.

Although in this figure, elements such as the at least one processor 1708, receiving circuitry 1704, and transmitting circuitry 1706 are described in the singular, the plural is contemplated unless a limitation to the singular is explicitly stated. In some embodiments of the subject application, the receiving circuitry 1704 and the transmitting circuitry 1706 can be combined into a single device, such as a transceiver. In certain embodiments of the subject application, the apparatus 1700 may further include an input device, a memory, and/or other components.

In some embodiments of the subject application, the non-transitory computer-readable medium 1702 may have stored thereon computer-executable instructions to cause a processor to implement the methods with respect to a UE or a network node (e.g., a BS) as described or illustrated above. For example, the computer-executable instructions, when executed, cause the processor 1708 interacting with receiving circuitry 1704 and transmitting circuitry 1706, so as to perform the steps with respect to a UE or a network node (e.g., a BS) as described or illustrated above.

FIG. 18 illustrates a further exemplary block diagram of an apparatus 1800 for a power saving operation in accordance with some embodiments of the subject application. Referring to FIG. 18, the apparatus 1800, for example a BS or a UE, may include at least one processor 1802 and at least one transceiver 1804 coupled to the at least one processor 1802. The transceiver 1804 may include at least one separate receiving circuitry 1806 and transmitting circuitry 1808, or at least one integrated receiving circuitry 1806 and transmitting circuitry 1808. The at least one processor 1802 may be a CPU, a DSP, a microprocessor etc.

According to some embodiments of the subject application, when the apparatus 1800 is a UE, the processor 1802 is configured to: receive a first configuration for one or more serving cells in a discontinuous reception (DRX) group via the transceiver 1804 from a network, wherein the first configuration includes at least one of: DRX cycle information used for determining a non-integer length value of a DRX cycle; or DRX start offset information which indicates an offset value related to a reference SFN in a time domain; and determine first start timing of an on-duration window for the DRX group in the time domain according to at least one of the DRX cycle information or the DRX start offset information.

According to some embodiments of the subject application, when the apparatus 1800 is a UE, the processor 1802 is configured to: receive a second configuration for one or more serving cells in a DRX group via the transceiver 1804 from a network, wherein the second configuration indicates a subset of an on-duration window for the DRX group in a time domain; and monitor a PDCCH transmission in the subset of the on-duration window according to the second configuration.

According to some embodiments of the subject application, when the apparatus 1800 is a UE, the processor 1802 is configured to: receive a configuration regarding DCP functionality via the transceiver 1804 from a network, wherein the configuration includes at least one of: DCP cycle information used for determining a non-integer length value of a DCP cycle: DCP start offset information which indicates an offset value related to a reference SFN in a time domain; or DCP on-duration information indicating which occasion(s) in the time domain are needed for monitoring a PDCCH transmission in an on-duration window of the DCP cycle.

According to some other embodiments of the subject application, when the apparatus 1800 is a network node (e.g., a BS), the processor 1802 is configured to receive a capability supporting an operation for determining start timing of an on-duration window for a DRX group in a time domain of a UE via the transceiver 1804 from the UE; and transmit a configuration for one or more serving cells in the DRX group via the transceiver 1804 to the UE, wherein the configuration includes at least one of: DRX cycle information used for determining a non-integer value of a DRX cycle: DRX start offset information which indicates an offset value related to a reference SFN in the time domain; or information associated with the reference SFN.

According to some other embodiments of the subject application, when the apparatus 1800 is a network node (e.g., a BS), the processor 1802 is configured to: receive a capability supporting an operation for monitoring a PDCCH transmission in a subset of an on-duration window for a DRX group of a UE via the transceiver 1804 from the UE; and transmit a configuration for one or more serving cells in the DRX group via the transceiver 1804 to the UE, wherein the configuration indicates a subset of the on-duration window for the DRX group in a time domain.

According to some other embodiments of the subject application, when the apparatus 1800 is a network node (e.g., a BS), the processor 1802 is configured to: receive a capability supporting an operation for determining start timing of an on-duration window of a DCP cycle in a time domain of a UE via the transceiver 1804 from the UE; and transmit a configuration regarding DCP functionality via the transceiver 1804 to the UE, wherein the configuration includes at least one of: DCP cycle information used for determining a non-integer length value of a DCP cycle; DCP start offset information which indicates an offset value related to a reference SFN in a time domain; or DCP on-duration information indicating which occasions in the time domain are needed for monitoring a PDCCH transmission in an on-duration window of the DCP cycle.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first.” “the second” or the like is only used to clearly illustrate the embodiments of the subject application, but is not used to limit the substance of the subject application.

1. A user equipment (UE) for wireless communication, comprising:
at least one memory; and
at least one processor coupled with the at least one memory and configured to cause the UE to:
receive a first configuration for one or more serving cells in a discontinuous reception (DRX) group from a network, wherein the first configuration includes at least one of:
DRX cycle information used for determining a non-integer length value of a DRX cycle; or
DRX start offset information which indicates an offset value related to a reference system frame number (SFN) in a time domain; and
determine first start timing of an on-duration window for the DRX group in the time domain according to at least one of the DRX cycle information or the DRX start offset information.

2. The UE of claim 1, wherein the at least one processor is configured to cause the UE to determine second start timing of the on-duration window for the DRX group in the time domain according to at least one of the DRX cycle information or the DRX start offset information.

3. The UE of claim 1, wherein the first configuration further includes information associated with the reference SFN, and wherein the at least one processor is configured to cause the UE to determine the first start timing of the on-duration window according to information associated with the reference SFN.

4-14. (canceled)

15. A network node for wireless communication, comprising:
at least one memory; and
at least one processor coupled with the at least one memory and configured to cause the network node to:
receive a capability supporting an operation for determining start timing of an on-duration window for a discontinuous reception (DRX) group in a time domain of a user equipment (UE) from the UE; and
transmit a configuration for one or more serving cells in the DRX group to the UE, wherein the configuration includes at least one of:
DRX cycle information used for determining a non-integer value of a DRX cycle;
DRX start offset information which indicates an offset value related to a reference system frame number (SFN) in the time domain; or
information associated with the reference SFN.

16. The network node of claim 15, wherein the at least one processor is configured to cause the network node to:
send non-integer DRX cycle information to a base station distributed unit (BS-DU) in a UE context setup request message or a UE context modification request message, so that the BS-DU can determine a DRX-On-Duration pattern for a DRX group according to the non-integer DRX cycle information.

17. A network node for wireless communication, comprising:
at least one memory; and
at least one processor coupled with the at least one memory and configured to cause the network node to:
receive non-integer DRX cycle information from a base station centralized unit (BS-CU) in a UE context setup request message or a UE context modification request message; and
determine a DRX-On-Duration pattern for a DRX group according to the non-integer DRX cycle information.

18. The UE of claim 1, wherein the at least one processor is configured to cause the UE to:
transmit uplink (UL) arrival jitter range information including at least one of:
a UL jitter range of data arrival time at the UE, which indicates the arrival jitter range relative to a configured periodical arrival time; or
a probability of the UL jitter range.

19. A processor for wireless communication, comprising:
at least one controller coupled with at least one memory and configured to cause the processor to:
receive a first configuration for one or more serving cells in a discontinuous reception (DRX) group from a network, wherein the first configuration includes at least one of:
DRX cycle information used for determining a non-integer length value of a DRX cycle; or
DRX start offset information which indicates an offset value related to a reference system frame number (SFN) in a time domain; and
determine first start timing of an on-duration window for the DRX group in the time domain according to at least one of the DRX cycle information or the DRX start offset information.

20. The processor of claim 19, wherein the at least one processor controller is configured to cause the processor to determine second start timing of the on-duration window for the DRX group in the time domain according to at least one of the DRX cycle information or the DRX start offset information.

21. The processor of claim 19, wherein the first configuration further includes information associated with the reference SFN, and wherein the at least one controller is configured to cause the processor to determine the first start timing of the on-duration window according to information associated with the reference SFN.

22. The processor of claim 19, wherein the at least one controller is configured to cause the processor to:
transmit uplink (UL) arrival jitter range information including at least one of:
a UL jitter range of data arrival time at the processor, which indicates the arrival jitter range relative to a configured periodical arrival time; or
a probability of the UL jitter range.
